(19) United States
(12) Patent Application Publication
(10) Pub. No.: US 2009/0237198 A1
(43) Pub. Date: Sep. 24, 2009

(54) SAFETY POWER DISCONNECTION TERMINAL APPARATUS WITH LIGHT INDICATION

(75) Inventor: Ming-Lin Yang, Hsinchu City (TW)

Correspondence Address: SCHMEISER, OLSEN & WATTS, 22 CENTURY HILL DRIVE, SUITE 302, LATHAM, NY, 12110, US

(73) Assignee: PHOTO-TOP TECHNOLOGIES CO., LTD., Hsinchu City (TW)

(21) Appl. No.: 12/478,355

(22) Filed: Jun. 4, 2009

Related U.S. Application Data
(63) Continuation-in-part of application No. 11/595,969, filed on Nov. 13, 2006.

(51) Int. Cl. H01H 85/32

(52) U.S. Cl. 337/266

(57) ABSTRACT

The present invention discloses a safety power disconnection terminal apparatus with light indication that includes: a housing, having two inspecting openings and a light transmitting portion provided at the top of the housing, and an opening provided at the bottom of the housing; a terminal pin installed in the housing, having two parallel conducting plates, and a fuse connected in between the two conducting plates. Terminal portions are provided at upper ends of the two conducting plates, and are exposed through the two inspecting openings, and L-shaped stands are provided at inner sides of the upper ends of the two conducting plates. A LED module has two LEDs serially connected with at least one voltage divided resistor that are mounted directly onto a surface of PCB.

### CROSS-REFERENCE TO RELATED APPLICATIONS

This application is a continuation-in-part patent application of U.S. application Ser. No. 11/595,969 filed on Nov. 13, 2006, the entire contents of which are hereby incorporated by reference for which priority is claimed under 35 U.S.C. § 120.

### FIELD OF THE INVENTION

The present invention relates to a safety power disconnection terminal apparatus with a light indication, and more particularly to a safety power disconnection terminal apparatus that can achieve the effect of expediting the installation and lowering the manufacturing cost.

### BACKGROUND OF THE INVENTION

A conventional blade fuse, such as the fault-indicating blade fuse shown in U.S. Pat. No. 5,598,138, normally has two long and flat, generally rectangular, dielectric bodies which are defined by top, bottom and opposite side margins. The lower parts of the dielectric bodies project downwardly beyond the bottom margin of the body, and the upper parts consist of narrow and long profiles lying within rectangular openings of the fuse body, and a link element within the body is electrically interconnected the blades and is fusible to break the interconnection when is subjected to current exceeding a rated value. A light-emitting electrical device, consists of incandescent lamps and at least one light-emitting diode (LED), is located above the fuse and connected to the blades through the contact element, such as solder, to be activated for light emission. The light-emitting electric device of the conventional blade fuse is either directly soldered onto the fuse body, or mounted to the blades. Further, the light-emitting diodes are connected in parallel and biased for passage of direct current between the blades in opposite directions so as the dual polarity of the diodes for the fault-indication can be achieved.

This conventional design has several disadvantage features, such as the light-emitting diodes are directly soldered to the blades, and the fuse wire is also soldered to the fuse plate, as a result, the LED is not firmly secured to the fuse when the soldering is not done properly, and the connection of the fuse is easily affected when it is subjected to high temperature. Further, the LED of the prior art is a one-directional (unidirectional) device, in which the LED is required to be installed to the fuse blades at certain directional in accordance with the polarity of the LED. The tungsten fuse used in the prior art has a limited voltage range. Moreover, the conventional blade fuse must be located at a predetermined orientation in the assembly, which is inconvenient and time consuming.

Another conventional fuse feature is shown in FIG. 1A. Referring to FIG. 1A for an exploded view of a conventional structure of a fuse terminal with light indication and FIG. 1B for a perspective view of a conventional structure of a fuse terminal with light indication, the structure includes:

a housing 1, having an opening 11 that penetrates the top and the bottom of the housing 1;

a terminal pin 2, comprised of two parallel metal conducting plates 21, a fuse 22 connected between the two metal conducting plates 21, a terminal portion 24 disposed at an upper end 23 of the metal conducting plate 21, and a L-shape stand 25 having an outwardly extended free end and disposed at an internal side of an upper end 23 of the metal conducting plate 21;

an upper casing 3, being a transparent object, for covering the corresponding opening 11 at the top of the housing 1, and having two inspecting openings 31;

a light emitting device 4, connected across the two L-shape stands 25 of the terminal pin 2, for connecting the two light emitting diodes in parallel first before packaging, so that two external contact points are formed at its surface as shown in FIG. 1B. The light emitting device 4 consists of two separated LEDs 73 and one resistor 74 shown in FIG. 3, in which the light emitting device 4 is directly mounted to the terminal pin 2 as shown in FIG. 1B in assembly.

Referring to FIG. 1B for a perspective view of a conventional structure of a fuse terminal with light indication, the terminal pin 2 is inserted and fixed into the housing 1 through the opening 11 at the top of the housing 1, such that upper and lower ends of the terminal pin 2 are exposed via the housing 1. The light emitting device 4 is then connected to the two L-shape stands 25 of the terminal pin 2 through the opening 11 of the housing 1, the upper casing 3 is used to cover the opening 11 at the top of the housing 1 once the light emitting device 4 is assembled onto the terminal pin 2, and the terminal portions 24 of the terminal pin 2 can be placed into the inspecting openings 31 of the upper casing 3. Obviously, the fabrication process of the conventional fuse terminal of light indication requires two separated molds for producing the upper casing 3 and housing 1, and since the molding process is complicated, the manufacturing cost will increase. The light emitting device 4 is mounted directly onto the terminal pin 2 in the conventional assembly process.

Referring to FIG. 3 for an equivalent circuit diagram of a conventional fuse terminal with light indication, the light emitting device 4 is composed of two light emitting diodes 73 that are installed in opposite directions, and the light emitting diodes 73 are connected in parallel, and a resistor 74 is connected in series in the circuit. If the fuse is blown, the current will flow through one of light emitting diodes only (the one has the same direction as the current direction), unidirectional flow, to allow the light emitting device to function. However, the two light emitting diodes 73 are installed in opposite directions and are connected in parallel in circuit, the overall size of the light emitting device 4 takes a lot space and cannot be reduced easily. From FIGS. 1A, 1B and 2, the conventional light emitting device 4 have to comprise two separated LEDs 73 and one resistors at least, therefore, its size is considerable large and cannot be decreased easily.

Therefore, it is an objective of present invention to provide an improved structure of a safety power disconnection terminal apparatus with light indication that can expedite the installation, and lower the manufacturing cost.

### SUMMARY OF THE INVENTION

In view of the foregoing shortcomings of the conventional fuse terminals, the inventor of the present invention based on years of experience to conduct extensive researches and experiments, and finally developed a safety power disconnection terminal apparatus with light indication to achieve the effect of expediting the installation and lower the manufacturing cost.

It is a primary objective of the present invention to provide a safety power disconnection terminal apparatus with light indication that can achieve the effect of expediting the installation and reducing the manufacturing cost.

To achieve the foregoing objective, a safety power disconnection terminal apparatus with light indication of the present invention comprises: a housing, having two inspecting openings and a light transmitting portion, wherein the two inspecting openings are both disposed at the top of the housing, and an opening is disposed at the bottom of the housing; a terminal pin, installed in the housing through the openings and composed of two parallel conducting plates and a fuse connected between the two conducting plates; a terminal portion is provided at an upper end of the two conducting plates and is integrated into the two inspecting openings; and a L-shape stand is disposed near the internal side of the upper end of the two conducting plates; a LED module consists of LEDs and resistor(s) is installed in the light transmitting portion, and its two electrodes are in contact with the two L-shape stands respectively, wherein the LED module is mounted directly onto a surface of PCB (printed circuited board) through the high temperature endurance and the SMT (surface-mount technology) method into one LED module. The two LEDs are packaged together with the resistor(s) onto one PCB to form one LED module, in which the LED module is then directly assembled with the light L-shape stands without solder. The design of the housing of the present invention simplifies the assembly processes, and lower the manufacturing cost, wherein the LED module has bi-directional characteristic that consists of bipolar conducting layers of different polarities. As a result, the LED module can be coupled with another load without the need of distinguishing positive and negative contact points, and always maintains a conducting layer in an electrically connected state, and ends of two voltage dividing resistors of the LED module are coupled respectively to the two conducting plates, and the terminal pin is installed at a load or a power source, such that if a current exceeds a rated value, the fuse will be burned to produce an open circuit, and a current will be passed through the light emitting device to light up the bipolar light emitting diode (LED). Therefore, the present invention can achieve the effects of expediting the installation and lowering the manufacturing cost.

### BRIEF DESCRIPTION OF THE DRAWINGS

FIG. 1A is an exploded view of a conventional structure of a fuse terminal with light indication;

FIG. 1B is a perspective view of the partially assembled conventional fuse structure;

FIG. 2 is a perspective view of the assembled conventional fuse structure;

FIG. 3 is an equivalent circuit diagram of a conventional fuse terminal with light indication;

FIG. 4 is an exploded view of a structure of safety power disconnection terminal apparatus with light indication in accordance with a preferred embodiment of the present invention;

FIG. 5 is a perspective view of a structure of the present invention;

FIG. 6 is an equivalent circuit diagram of the present invention; and

FIG. 7 is a perspective view of a module constructing of SMD LED on a PCB in accordance with the preferred embodiment of the present invention.

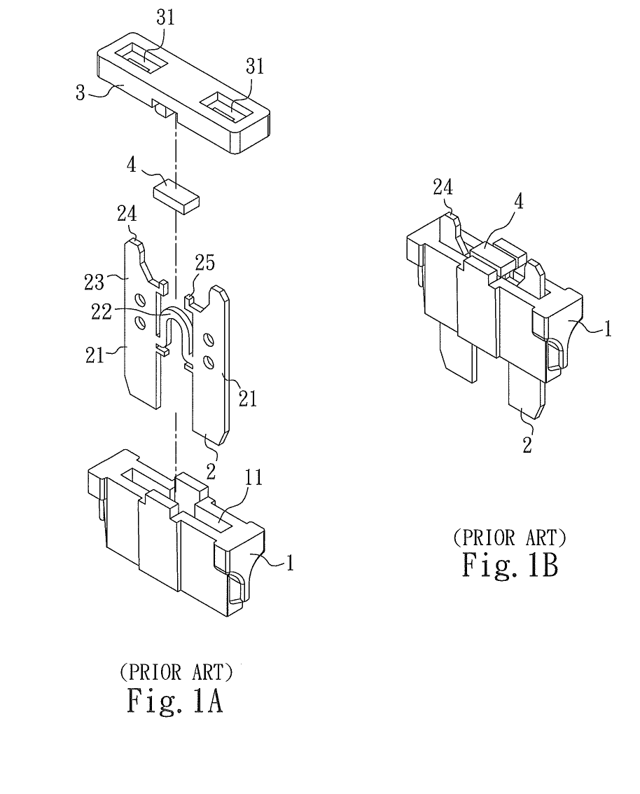

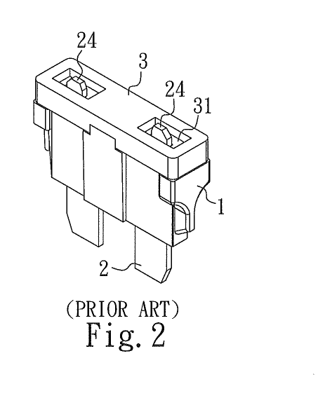

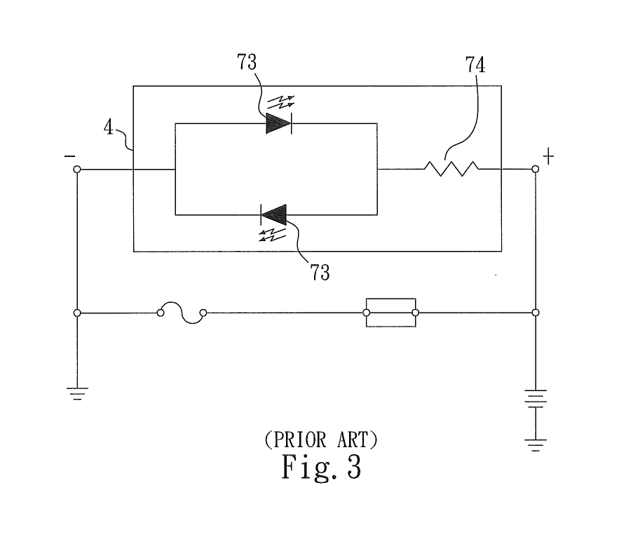

### DETAILED DESCRIPTION OF THE PREFERRED EMBODIMENTS

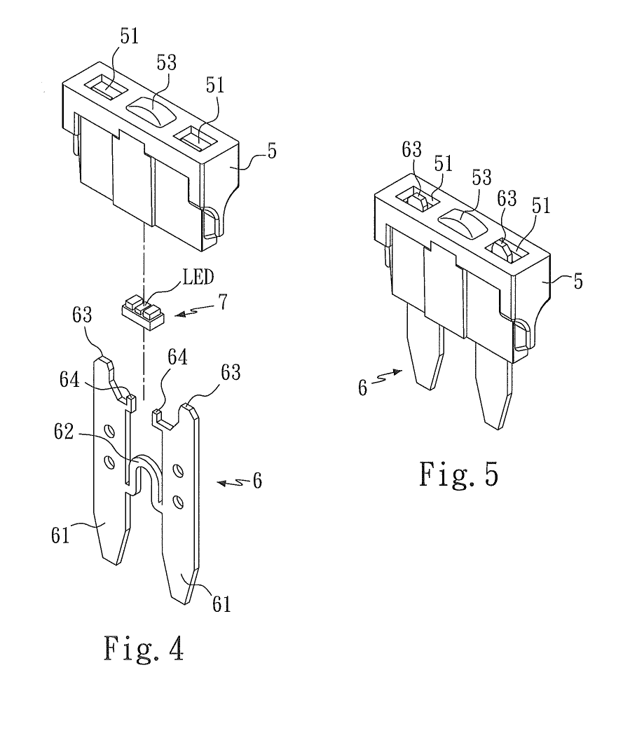

Referring to FIG. 4 for an exploded view of the present invention, the invention comprises:

an integrally formed housing 5, having two inspecting openings 51 and a light transmitting portion 53 disposed at the top of the housing 5 and an opening disposed at the bottom of the housing 5; a terminal pin 6, installed into the housing 5 through the openings, wherein the terminal pin 6 comprises of two parallel conducting plates 61 and a fuse 62 connected the two conducting plates 61. Two terminal portions 63 are extended from the top ends of the two conducting plates 61 respectively, in which the two terminal portions 63 are exposed through the inspecting openings 51 when the terminal pin 6 is integrated into the housing 5. L-shaped stands 64 are provided at the inner sides of the upper ends of the two conducting plates 61, wherein the L-shaped stands 64 are directly electrical in contact with a LED (light emitting diodes) module 7 when the LED module 7 and the terminal pin 6 are integrated into the housing 5, and the LED module 7 is then assembled into the light transmitting portion 53 of the housing 5. The integrally housing 5 of the invention does not require two separated molds to fabricate as those conventional fuses that require two separated molds for making the main housing and upper casting.

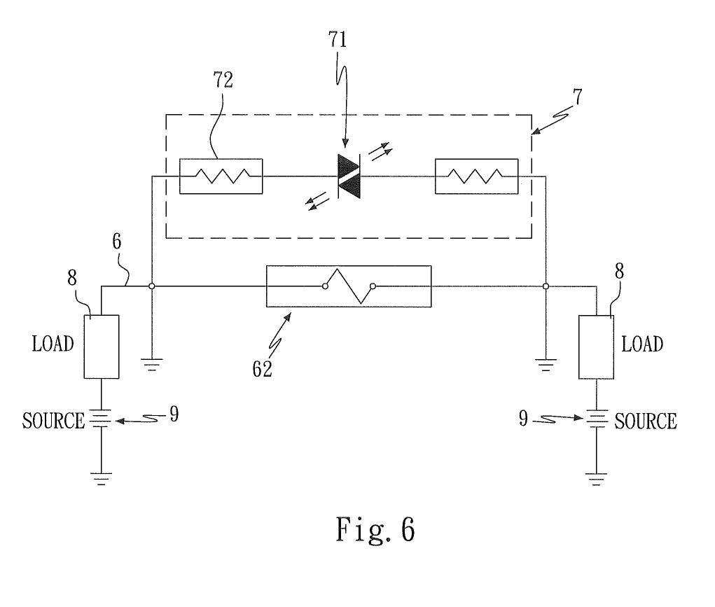

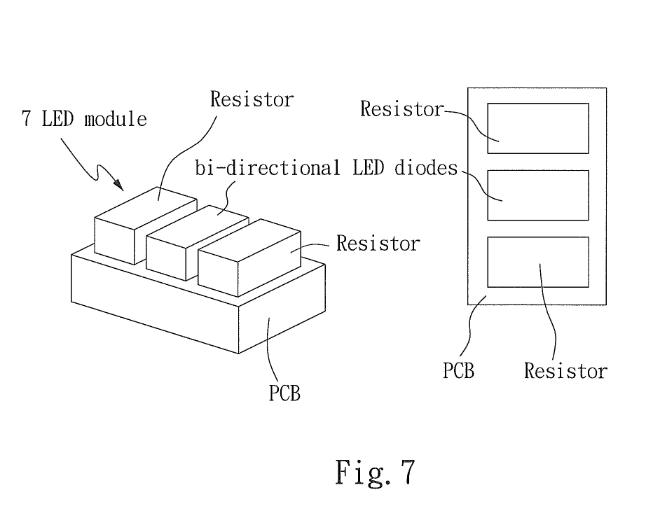

The LED module 7 of the present invention consists of a SMD (Surface Mounting Form) LED set. Referring to FIGS. 6 and 7, the LED module, comprises two LEDs serially connected with at least one voltage divided resistor, which is mounted directly onto a surface of a specific PCB (printed circuited board) through the high temperature endurance and the SMT (surface-mount technology) method into one LED module, and since the technique involved the SMT method, the LED module is also known as a SMD LED module. In other words, the two LEDs and resistor(s) of the present invention are packaged to one PCB together as one single LED module. The LED module of the present invention is very different from the conventional SMD LED sets that comprise two separated LEDs and resistor(s), which are not packaged and constructed together to the PCB because they are either directly mounted to the fuse blades without packaging to the PCB. The PCB utilized in our invention can endure high temperature, and is preferably made of materials consisting of CCL (Copper Clab Laminate) but is not limited to the CCL material only.

The LED module 7 shown in FIGS. 6 & 7 is a bi-directional SMD LED set so that the LED module 7 of the present invention can be used bi-directionally. In other words, the LED module 7 is assembled to the terminal pin 6 and housing 5 without the need of distinguishing the positive and negative contact points, and it further comprises a conducting layer that can always permit the LED module 7 to be electrical connected. Ends of the two voltage dividing resistors are connected to the two conducting plates 62 respectively, and the terminal pin 6 can be installed in the load 8 or the power source 9. When the current exceeds a rated value, the fuse 62 will be blown to produce an open circuit to force the current to pass through the LED module 7 to light up the Bipolar LED set in order to inform the maintenance personnel about a particular abnormal section of the circuit that requires maintenance or repair service.

The SMD LED set of the present invention is mounted directly onto the PCB configuring to the module as shown in FIG. 7, unlike the prior art SMD LED set which is integrated directly to the fuse. The prior art SMD LED set, when one of the devices is broken, the whole SMD LED set will suffer dysfunctional because of the set is mounted directly onto the fuse. The LED module of the present invention constructs the SMD components directly on the PCB before assembling to the fuse. Therefore, it still can function even when one of the LEDs is broken. The broken device can be repaired easily from the PCB without damaging other devices. The LED module has high degree of contact for better connection. Further, the PCB of the present invention is made of specific materials, such as CCL, that can subject to higher temperature, approximately above 300° C., which the prior art SMD LED sets are unable to sustain to high temperature. As a result, the LED module also has high resistance to impact and distortion, and its stress and strength are increased which can subject to a higher temperature range. Since the SMD LED components are mounted directly onto the specific PCB, it can be produced automatically with a higher production rate and the maintain/repair cost can be reduced.

The light transmitting portion 53 has a cambered surface protruded outward from the top of the housing 5 so that the light emission of the LED module 7 can pass through the cambered surface to provide a wider lighting range. The designs of the housing 5 and terminal pin 6 of the present invention, the two electrodes of the light emitting device 53 can directly electrical connect to the two L-shape stands without soldering process.

Referring to FIG. 5 for a perspective view of a structure of the present invention, the LED module 7 is installed in the light transmitting portion 53 of the housing 5 first, then the terminal pin 6 is assembled into the housing 5 in such that the terminal portions 63 are exposed through the inspecting openings 51, and the two conducting plates 61 are exposed and protruded through the bottom opening of the housing 5, wherein the L-shaped stands 64 of the terminal pin 6 are designed to secure the position of the LED module 7 inside the housing 5, and to directly electrical connect to the diodes of the LED module 7.

The improved structural design of the present invention can save the cost of making conventional molds for the separate parts of the housing, and it also can simplify the integration process by eliminating the solder process for the LED module 7 and the terminal pin 6. As a result, the present invention definitely achieves the effects of expediting the installation and lowering the manufacturing cost.

The present embodiment is to be considered as illustrative and not restrictive, and the invention is not to be limited to the details given therein, but may be modified within the scope and equivalence of the appended claims.

1. A safety power disconnection terminal apparatus with light indication, comprising:
a housing, having two inspecting openings and a light transmitting portion, wherein the two inspecting openings and the light transmitting portion are located at the top of the housing, and an opening is provided at the bottom of the housing;
a terminal pin, installed in the housing through the opening, wherein the terminal pin comprises two parallel conducting plates, and a fuse connected in between the two conducting plates, terminal portions are provided at an upper part of the two conducting plates respectively, and are exposed through the two inspecting openings, L-shaped stands are provided at inner sides of two conducting plates; and
a LED module, installed in the light transmitting portion of the housing, and having two bi-directional diodes directly electrically connected to the two L-shaped stands respectively during assembly, the light emission from the LED module is visible through the light transmitting portion of the housing, wherein the LED module further comprises two LEDs serially connected with at least one voltage divided resistor, and the LEDs and the resistor are mounted directly onto a surface of PCB configuring into one module.

2. The safety power disconnection terminal apparatus with light indication of claim 1, wherein the LED module constructs and packages the two LEDs and the resistor onto the PCB as one package.

3. The safety power disconnection terminal apparatus with light indication of claim 1, wherein the light transmitting portion has a shape of a cambered surface protruded outward from the top of the housing.

4. The safety power disconnection terminal apparatus with light indication of claim 1, wherein the PCB is made of materials consisting of CCL (Copper Clab Laminate).

5. The safety power disconnection terminal apparatus with light indication of claim 1, wherein PCB is capable of sustaining to a temperature approximately 300° C.
